(19) United States
(12) Patent Application Publication
(10) Pub. No.: US 2025/0106028 A1
(43) Pub. Date: Mar. 27, 2025

(54) CRYPTO TOKEN THRESHOLD NOTIFICATIONS

(71) Applicant: Coinbase, Inc., Oakland, CA (US)

(72) Inventors: Logan James Dirkx, San Francisco, CA (US); Raymond Sohn, San Leandro, CA (US); Sri Rao, Stony Brook, NY (US)

(21) Appl. No.: 18/372,052

(22) Filed: Sep. 22, 2023

(51) Int. Cl. H04L 9/32

(52) U.S. Cl. CPC H04L 9/3226

(57) ABSTRACT

Methods, systems, and devices for data management are described. A server may determine that a current characteristic of a crypto token satisfies a notification condition associated with an application on one or more user devices. The server may transmit a payload that causes a push notification associated with the application on a user device to be displayed at the user device. The push notification may be indicative of the notification condition. The server may receive, from the application, a request for information associated with the crypto token in response to an input activating the push notification at the user device. The server may transmit a response including the information associated with the crypto token. The response may cause display of a token page at the application associated with the crypto token including notification condition information included in the payload.

### FIELD OF TECHNOLOGY

The present disclosure relates generally to data management, including techniques for crypto token threshold notifications.

### BACKGROUND

Blockchains and related technologies may be employed to support recordation of ownership of digital assets, such as cryptocurrencies, fungible tokens, non-fungible tokens (NFTs), and the like. Generally, peer-to-peer networks support transaction validation and recordation of transfer of such digital assets on blockchains. Various types of consensus mechanisms may be implemented by the peer-to-peer networks to confirm transactions and to add blocks of transactions to the blockchain networks. Example consensus mechanisms include the proof-of-work consensus mechanism implemented by the Bitcoin network and the proof-of-stake mechanism implemented by the Ethereum network. Some nodes of a blockchain network may be associated with a digital asset exchange, which may be accessed by users to trade digital assets or trade a fiat currency for a digital asset.

### BRIEF DESCRIPTION OF THE DRAWINGS

FIG. 1 illustrates an example of a computing environment that supports crypto token threshold notifications in accordance with aspects of the present disclosure.

FIG. 2 shows an example of a computing environment that supports crypto token threshold notifications in accordance with aspects of the present disclosure.

FIG. 3 shows an example of a user interface diagram that supports crypto token threshold notifications in accordance with aspects of the present disclosure.

FIG. 4 shows an example of a process flow that supports crypto token threshold notifications in accordance with aspects of the present disclosure.

FIG. 5 shows a block diagram of an apparatus that supports crypto token threshold notifications in accordance with aspects of the present disclosure.

FIG. 6 shows a block diagram of a threshold notification manager that supports crypto token threshold notifications in accordance with aspects of the present disclosure.

FIG. 7 shows a diagram of a system including a device that supports crypto token threshold notifications in accordance with aspects of the present disclosure.

FIGS. 8 and 9 show flowcharts illustrating methods that support crypto token threshold notifications in accordance with aspects of the present disclosure.

### DETAILED DESCRIPTION

A user may access an application associated with a custodial token platform via a user device to trade, use, or exchange crypto tokens. For example, users of the application may buy, sell, trade, or otherwise exchange amounts of one or more crypto tokens via the custodial token platform. In some cases, users may trade amounts of the one or more crypto tokens based on current conditions of the one or more crypto tokens relative to historic conditions, the crypto market, or both. That is, the users may determine to trade or acquire a token based on price action relative to historical price action. However, users may be unaware of current conditions relative to the historic conditions, the crypto market, or both, and, thus, may refrain from trading.

As described herein, the application may notify users based on a current characteristic of a crypto token satisfying a notification condition. For example, a server supporting the application may determine that the current characteristic satisfies the notification condition and transmit a payload causing a push notification to be displayed at a user device having the application. The notification condition may be the current condition being within a threshold support level or resistance level, or exceeding a support level or resistance level. Additionally, or alternatively, the notification condition may be satisfied based on the current characteristic relative to a historic support level or resistance level. For example, the server may determine the historic support level or resistance level based on exchange activity associated with the crypto token. These and other techniques are described in further detail with respect to the figures.

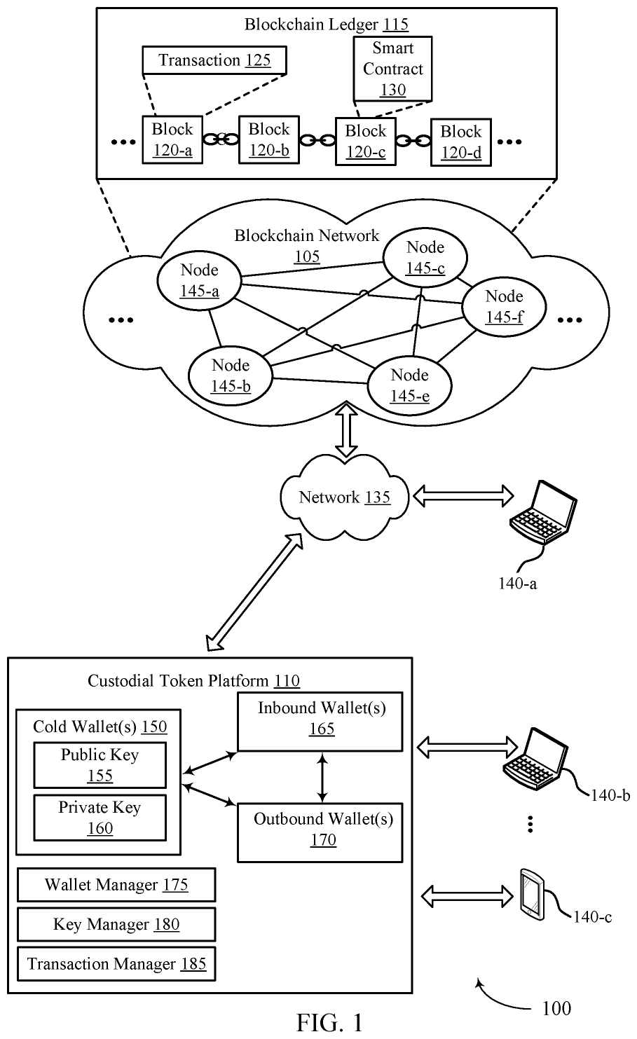

FIG. 1 illustrates an example of a computing environment 100 that supports crypto token threshold notifications in accordance with aspects of the present disclosure. The computing environment 100 may include a blockchain network 105 that supports a blockchain ledger 115, a custodial token platform 110, and one or more computing devices 140, which may be in communication with one another via a network 135.

The network 135 may allow the one or more computing devices 140, one or more nodes 145 of the blockchain network 105, and the custodial token platform 110 to communicate (e.g., exchange information) with one another. The network 135 may include aspects of one or more wired networks (e.g., the Internet), one or more wireless networks (e.g., cellular networks), or any combination thereof. The network 135 may include aspects of one or more public networks or private networks, as well as secured or unsecured networks, or any combination thereof. The network 135 also may include any quantity of communications links and any quantity of hubs, bridges, routers, switches, ports or other physical or logical network components.

Nodes 145 of the blockchain network 105 may generate, store, process, verify, or otherwise use data of the blockchain ledger 115. The nodes 145 of the blockchain network 105 may represent or be examples of computing systems or devices that implement or execute a blockchain application or program for peer-to-peer transaction and program execution. For example, the nodes 145 of the blockchain network 105 support recording of ownership of digital assets, such as cryptocurrencies, fungible tokens, non-fungible tokens (NFTs), and the like, and changes in ownership of the digital assets. The digital assets may be referred to as tokens, coins, crypto tokens, or the like. The nodes 145 may implement one or more types of consensus mechanisms to confirm transactions and to add blocks (e.g., blocks 120-a, 120-b, 120-c, and so forth) of transactions (or other data) to the blockchain ledger 115. Example consensus mechanisms include a proof-of-work consensus mechanism implemented by the Bitcoin network and a proof-of-stake consensus mechanism implemented by the Ethereum network.

When a device (e.g., the computing device 140-a, 140-b, or 140-c) associated with the blockchain network 105 executes or completes a transaction associated with a token supported by the blockchain ledger, the nodes 145 of the blockchain network 105 may execute a transfer instruction that broadcasts the transaction (e.g., data associated with the transaction) to the other nodes 145 of the blockchain network 105, which may execute the blockchain application to verify the transaction and add the transaction to a new block (e.g., the block 120-d) of a blockchain ledger (e.g., the blockchain ledger 115) of transactions after verification of the transaction. Using the implemented consensus mechanism, each node 145 may function to support maintaining an accurate blockchain ledger 115 and prevent fraudulent transactions.

The blockchain ledger 115 may include a record of each transaction (e.g., a transaction 125) between wallets (e.g., wallet addresses) associated with the blockchain network 105. Some blockchains may support smart contracts, such as smart contract 130, which may be an example of a sub-program that may be deployed to the blockchain and executed when one or more conditions defined in the smart contract 130 are satisfied. For example, the nodes 145 of the blockchain network 105 may execute one or more instructions of the smart contract 130 after a method or instruction defined in the smart contract 130 is called by another device. In some examples, the blockchain ledger 115 is referred to as a blockchain distributed data store.

A computing device 140 may be used to input information to or receive information from the custodial token platform 110, the blockchain network 105, or both. For example, a user of the computing device 140-a may provide user inputs via the computing device 140-a, which may result in commands, data, or any combination thereof being communicated via the network 135 to the custodial token platform 110, the blockchain network 105, or both. Additionally, or alternatively, a computing device 140-a may output (e.g., display) data or other information received from the custodial token platform 110, the blockchain network 105, or both. A user of a computing device 140-a may, for example, use the computing device 140-a to interact with one or more user interfaces (e.g., graphical user interfaces (GUIs)) to operate or otherwise interact with the custodial token platform 110, the blockchain network 105, or both.

A computing device 140 and/or a node 145 may be a stationary device (e.g., a desktop computer or access point) or a mobile device (e.g., a laptop computer, tablet computer, or cellular phone). In some examples, a computing device 140 and/or a node 145 may be a commercial computing device, such as a server or collection of servers. And in some examples, a computing device 140 and/or a node 145 may be a virtual device (e.g., a virtual machine).

Some blockchain protocols support layer one and layer two crypto tokens. A layer one token is a token that is supported by its own blockchain protocol, meaning that the layer one token (or a derivative thereof), may be used to pay transaction fees for transacting using the blockchain protocol. A layer two token is a token that is built on top of layer one, for example, using a smart contract 130 or a decentralized application (“Dapp”). The smart contract 130 or decentralized application may issue layer two tokens to various users based on various conditions, and the users may transact using the layer two tokens, but transaction fees may be based on the layer one token (or a derivative thereof).

The custodial token platform 110 may support exchange or trading of digital assets, fiat currencies, or both by users of the custodial token platform 110. The custodial token platform 110 may be accessed via website, web application, or applications that are installed on the one or more computing devices 140. The custodial token platform 110 may be configured to interact with one or more types of blockchain networks, such as the blockchain network 105, to support digital asset purchase, exchange, deposit, and withdrawal.

For example, users may create accounts associated with the custodial token platform 110 such as to support purchasing of a digital asset via a fiat currency, selling of a digital asset via fiat currency, or exchanging or trading of digital assets. A key management service (e.g., a key manager) of the custodial token platform 110 may create, manage, or otherwise use private keys that are associated with user wallets and internal wallets. For example, if a user wishes to withdraw a token associated with the user account to an external wallet address, key manager 180 may sign a transaction associated with a wallet of the user, and broadcast the signed transaction to nodes 145 of the blockchain network 105, as described herein. In some examples, a user does not have direct access to a private key associated with a wallet or account supported or managed by the custodial token platform 110. As such, user wallets of the custodial token platform 110 may be referred to non-custodial wallets or non-custodial addresses.

The custodial token platform 110 may create, manage, delete, or otherwise use various types of wallets to support digital asset exchange. For example, the custodial token platform 110 may maintain one or more internal cold wallets 150. The internal cold wallets 150 may be an example of an offline wallet, meaning that the cold wallet 150 is not directly coupled with other computing systems or the network 135 (e.g., at all times). The cold wallet 150 may be used by the custodial token platform 110 to ensure that the custodial token platform 110 is secure from losing assets via hacks or other types of unauthorized access and to ensure that the custodial token platform 110 has enough assets to cover any potential liabilities. The one or more cold wallets 150, as well as other wallets of the blockchain network 105 may be implemented using public key cryptography, such that the cold wallet 150 is associated with a public key 155 and a private key 160. The public key 155 may be used to publicly transact via the cold wallet 150, meaning that another wallet may enter the public key 155 into a transaction such as to move assets from the wallet to the cold wallet 150. The private key 160 may be used to verify (e.g., digitally sign) transactions that are transmitted from the cold wallet 150, and the digital signature may be used by nodes 145 to verify or authenticate the transaction. Other wallets of the custodial token platform 110 and/or the blockchain network 105 may similarly use aspects of public key cryptography.

The custodial token platform 110 may also create, manage, delete, or otherwise use inbound wallets 165 and outbound wallets 170. For example, a wallet manager 175 of the custodial token platform 110 may create a new inbound wallet 165 for each user or account of the custodial token platform 110 or for each inbound transaction (e.g., deposit transaction) for the custodial token platform 110. In some examples, the custodial token platform 110 may implement techniques to move digital asset between wallets of the digital asset exchange platform. Assets may be moved based on a schedule, based on asset thresholds, liquidity requirements, or a combination thereof. In some examples, movements or exchanges of assets internally to the custodial token platform 110 may be “off-chain” meaning that the transactions associated with the movement of the digital asset are not broadcast via the corresponding blockchain network (e.g., blockchain network 105). In such cases, the custodial token platform 110 may maintain an internal accounting (e.g., ledger) of assets that are associated with the various wallets and/or user accounts.

As used herein, a wallet, such as inbound wallets 165 and outbound wallets 170 may be associated with a wallet address, which may be an example of a public key, as described herein. The wallets may be associated with a private key that is used to sign transactions and messages associated with the wallet. A wallet may also be associated with various user interface components and functionality. For example, some wallets may be associated with or leverage functionality for transmitting crypto tokens by allowing a user to enter a transaction amount, a receiver address, etc. into a user interface and clicking or activating a UI component such that the transaction is broadcast via the corresponding blockchain network via a node (e.g., a node 145) associated with the wallet. As used herein, “wallet” and “address” may be used interchangeably.

In some cases, the custodial token platform 110 may implement a transaction manager 185 that supports monitoring of one or more blockchains, such as the blockchain ledger 115, for incoming transactions associated with addresses managed by the custodial token platform 110 and creating and broadcasting on-blockchain transactions when a user or customer sends a digital asset (e.g., a withdrawal). For example, the transaction manager 185 may monitor the addressees of the customers for transfer of layer one or layer two tokens supported by the blockchain ledger 115 to the addresses managed by the custodial token platform 110. As another example, when a user is withdrawing a digital asset, such as a layer one or layer two token, to an external wallet (e.g., an address that is not managed by the custodial token platform 110 or an address for which the custodial token platform 110 does not have access to the associated private key), the transaction manager 185 may create and broadcast the transaction to one or more other nodes 145 of the blockchain network 105 in accordance with the blockchain application associated with the blockchain network 105. As such, the transaction manager 185, or an associated component of the custodial token platform 110 may function as a node 145 of the blockchain network 105.

As described herein, the custodial token platform may implement and support various wallets including the inbound wallets 165, the outbound wallets 170, and the cold wallets 150. Further, the custodial token platform 110 may implement techniques to maintain and manage balances of the various wallets. In some examples, the balances of the various wallets are configured to support security and liquidity. For example, the custodial token platform 110 may implement transactions that move crypto tokens between the inbound wallets 165 and the outbound wallets 170. These transactions may be referred to as “flush” transactions and may occur on a periodic or scheduled basis.

As described herein, various transactions may be broadcast to the blockchain ledger 115 to cause transfer of crypto tokens, to call smart contracts, to deploy smart contracts etc. In some examples, these transactions may also be referred to as messages. That is, the custodial token platform 110 may broadcast a message to the blockchain network 105 to cause transfer of tokens between wallets managed by the custodial token platform 110 to cause transfer of tokens from a wallet managed by the custodial token platform 110 to an external wallet, to deploy a smart contract (e.g., a self-executing program), or to call a smart contract.

An application associated with the custodial token platform 110 on a computing device (e.g., the computing device 140-b, the computing device 140-c, etc.) may notify users based on a current characteristic of a crypto token satisfying a notification condition. For example, a server supporting the application, the custodial token platform 110, or both may determine that the current characteristic satisfies the notification condition and transmit a payload causing a push notification to be displayed at the computing device 140 having the application. The notification condition may be the current condition being within a threshold support level or resistance level, or exceeding a support level or resistance level. Additionally, or alternatively, the notification condition may be satisfied based on the current characteristic relative to a historic support level or resistance level. For example, the server may determine the historic support level or resistance level based on exchange activity associated with the crypto token.

As described herein, the custodial token platform 110 may execute a job that determines whether the notification condition is satisfied. For example, the job may continuously or periodically evaluate characteristic data, such a historical trading (e.g., price) data to determine trading support and resistance levels. In some cases, these support and resistance levels are determined for various time periods, such as an hour, day, month, year, or multiple years and for multiple crypto tokens. Generally, support and resistance levels may be arbitrarily determined by users based on trading patterns identified using price charts. However, the techniques described herein identify these support and/or resistance levels using algorithms and historical price data, and the notifications are triggered for users based on evaluations of current price data relative to the identified support and resistance levels.

Thus, the techniques described herein support multiple different advantages. For example, because the identification of support and/or resistance levels and evaluation of notification conditions are performed by the custodial token platform 110, the triggered notifications result in improved user experience and an improved user interface. That is, the user may not be required to determine support and resistance levels, which can utilize significant processing and memory resources on the computing device 140. Additionally, the user interface is improved based on simplification of the user interface. For example, drawing support/resistance lines on price charts by users may require complex user interfaces that are accessible only via large screens. These techniques allow support and resistance levels to be evaluated on mobile devices, typically with smaller screens with less complex user interfaces.

Furthermore, as described herein, the payload that is transmitted to the computing devices 140 include information that improves the user experience and the user interface. The payload includes information that is included in the push notification as well as information that is used when the push notification is triggered, activated, or otherwise selected. For example, if the user selects the push notification, then the application is opened on the user device and the application is configured to display information associated with the push notification, such as the notification condition in addition to the price chart. The payload may include the contextual information that the application uses to retrieve additional information to display in conjunction with the notification information. That is, the application may retrieve, using the contextual information in the payload, price information, chart information, or other content, which is displayed in conjunction with the information included in the payload (e.g., in the token page). As such, the techniques described herein support various improvements in user experience, user interfaces, and device functionality.

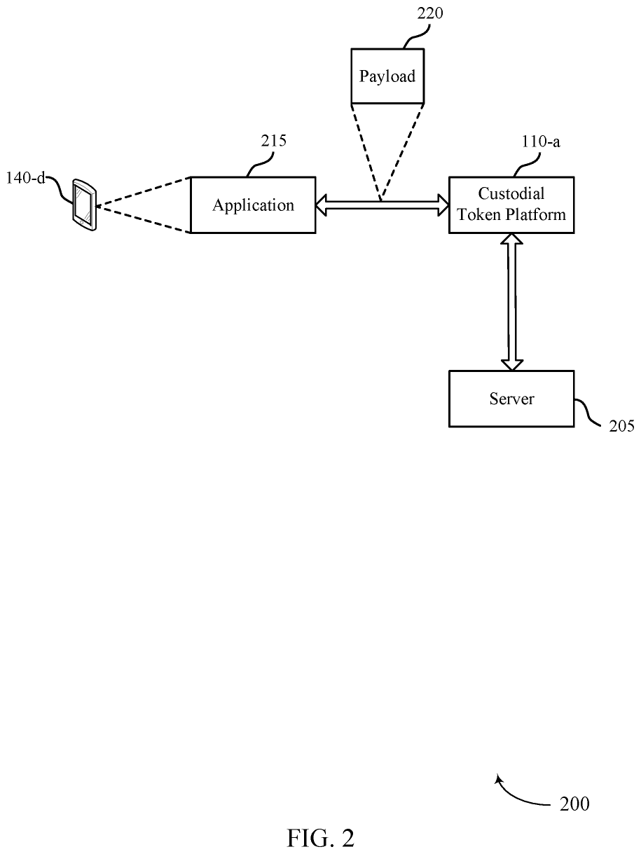

FIG. 2 shows an example of a computing environment 200 that supports crypto token threshold notifications in accordance with aspects of the present disclosure. The computing environment 200 may include a computing device 140-d and a custodial token platform 110-a, which may be examples of corresponding devices as described with reference to FIG. 1. The computing environment 200 may also include a server 205, which may be an example of one or more servers that support the custodial token platform 110-a.

The computing device 140-d may include an application 215 that is used to access the custodial token platform 110-a. The computing device 140-d may be an example of a user device, where the application is installed on or accessible via the user device. A user profile may be associated with the custodial token platform and may be used via the application 215 on the computing device 140-d.

The application of the custodial token platform 110-a may support an exchange of crypto tokens (e.g., buying, selling, trading, etc. an amount of a crypto token on a crypto market). One or more characteristics of crypto tokens may change over time. For example, a price, a resistance level, a support level, or the like may vary with respect to historic conditions. In some cases, a user of the application may be unaware of changes to the one or more characteristics and miss one or more opportunities to trade at favorable market conditions (e.g., to sell an amount of the crypto token when the price is high relative to historic conditions or buy an amount of the crypto token when the price is low relative to historic conditions). As such, the user may benefit from receiving notifications from the application on the computing device 140-d when the one or more characteristics reach a threshold.

The server 205 may monitor (e.g., periodically) for a characteristic (e.g., a current characteristic) of the crypto token. For example, the server 205 may monitor for the characteristic of the crypto token to satisfy a notification condition (e.g., the threshold) associated with the application on the computing device 140-d. The server 205 may determine that the current characteristic of the crypto token satisfies the notification condition associated with the application 215 on the computing device 140-d (e.g., the computing device 140-d and one or more other user devices) and transmit a payload 220 causing a push notification associated with the application to be displayed at a user interface of the computing device 140-d. The push notification may display information indicative of the notification condition being met.

For example, the server 205 may determine that the crypto token is associated with, for example, a support level below a historic low support level or above a historic high support level (e.g., within a time range of a day, month, year, five years, etc.). The push notification may indicate the support level relative to the historic low or the historic high support level. A support level may refer to a price level at which an asset (such as a stock, commodity, or cryptocurrency) tends to find buying interest. When the price of the asset falls towards its support level, it is perceived as a desirable buying opportunity, which can result in the price bouncing off this level rather than continuing its downward trajectory. Support levels may be determined by evaluating past price history. If the price of an asset has fallen to a particular level multiple times but has not significantly dropped below that level, traders might see this as a strong support level. In some cases, if a support level is breached, and the asset's price closes below it, that level can potentially become a new resistance level. This is based on the principle that roles of support and resistance tend to switch once broken. Volume is an important factor to consider when analyzing support levels. If an asset approaches a support level on increasing volume, the price action may indicate strong buying interest and validate the support level's significance. On the other hand, if the asset breaks through a support level on high volume, it may confirm a stronger bearish sentiment.

A resistance level refers to a price level at which an asset (such as a stock, commodity, or cryptocurrency) tends to find selling interest. When the price of the asset rises towards its resistance level, it is seen as a potential point where the asset may face difficulty in moving further upward. This can result in the price retracting or even reversing direction from this level. Resistance levels are often discerned by reviewing past price data. If the price of an asset has risen to a particular level multiple times but has not significantly surpassed that level, traders might consider this as a strong resistance level. Thus, the custodial token platform may evaluate various metrics and characteristics to determine support and resistance levels.

In some examples, the server 205, the custodial token platform 110, or both may execute one or more jobs that periodically or continuously monitors characteristics (e.g., price action) various crypto tokens. For example, a job may be used to determine support or resistance thresholds for a price of a token. The job may implement a technique or algorithm that determines a support or resistance level for a time period, such as an hour, day month, year, or multiple years. The same or a different job may monitor or retrieve a current price relative to the determine support or resistance threshold. One or more of the jobs may trigger the notification as described herein based on the current price relative to the threshold. For example, if the price is within some threshold price of the threshold, then the notification may be triggered. Additionally, or alternatively, if the price passes the threshold, then the notification may be triggered.

Additionally, the server 205, the custodial token platform 110, or both may execute a job that determines whether user profiles are classified as interested in a crypto token in order to determine whether to send a notification. For example, the job may add or remove user profiles from a list associated with a crypto token based on information associated with the user profile, such as whether the user profile has added the crypto token to favorites list or whether the user profile is associated with a wallet address that owns the crypto token. Additionally, a profile may be classified as interested based on the user interaction with content associated with the crypto token via the application 215. For example, if a user reads one or more news articles associated with the crypto token, then that user may be classified as interested in the crypto token. Thus, after the custodial token platform 110-a determines that the notification condition is satisfied, the custodial token platform 110-a may obtain a list of interested users and transmit the push notifications to devices corresponding to the interested users.

A user of the computing device 140-d may interact with the push notification. For example, the user may select the push notification, causing the computing device 140-d to request information associated with the crypto token (e.g., the crypto token indicated on the push notification) from the server 205. That is, the user may provide an input activating the push notification. In some cases, the payload 220 may include contextual information such that, when the push notification is selected (e.g., activated), the application 215 automatically navigates to the token page. For example, the payload 220 may include an indication of the crypto token. As such, when the notification is selected, the application 215 navigates to the token page. In some cases, when the application is opened in response to the activation of the push notification, the application 215 requests information associated with the crypto token (based on the information included in the payload) from the server 205. Thus, the server 205 may transmit, in response to the request from the application 215, information associated with the crypto token. For example, the server 205 may transmit a response to the request, causing a display at the computing device 140-d of a token page associated with the crypto token. The token page may include notification condition information included in the push notification. For example, the token page may include one or more threshold support lines or an indication or description of the support lines or thresholds. The information transmitted by the server may include price information, token characteristics, content (e.g., news items) associated with the token, etc.

The user may trade the crypto token via the token page. For example, the user may trade an amount of the crypto token via the token page based on the information associated with the crypto token, such as the one or more threshold support lines.

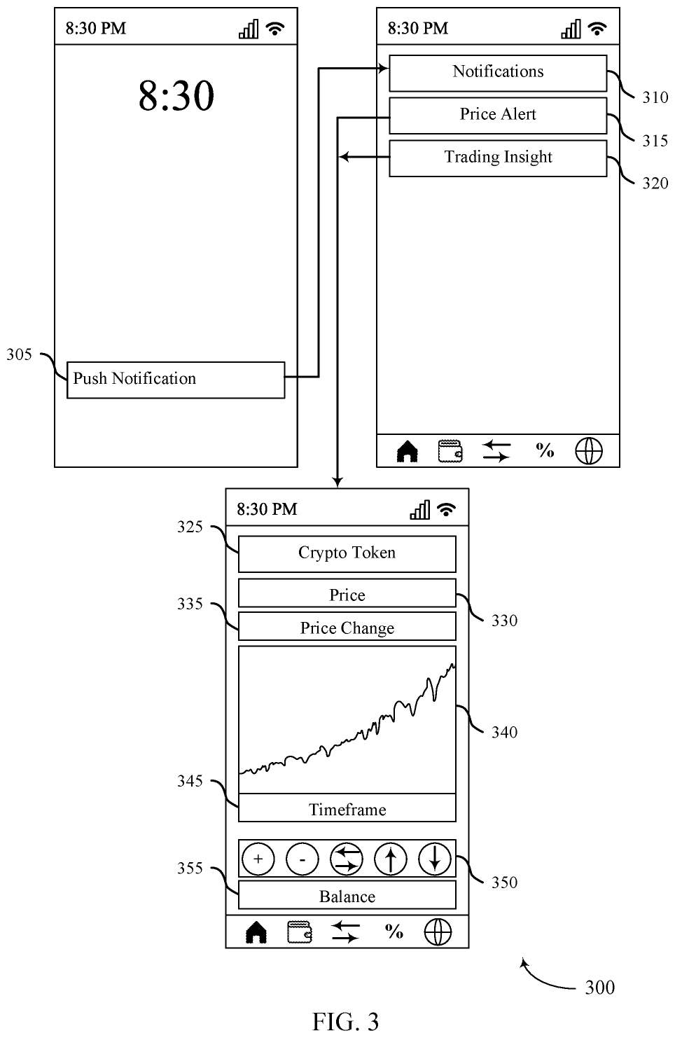

FIG. 3 shows an example of a user interface diagram 300 that supports crypto token threshold notifications in accordance with aspects of the present disclosure. The user interface diagram 300 may be implemented by an application of a custodial token platform on a user device, which may be examples of corresponding devices or systems as described with respect to FIGS. 1 and 2.

A user interface diagram 300 may display one or more notifications (e.g., push notifications), a token page, one or more trading options, or a combination thereof and receive one or more inputs to support crypto token threshold notifications as described herein. The user interface diagram 300 includes an example of a user interface flow wherein a user may receive a notification, interact with the notification, and select one or more options to trade a crypto token associated with the notification.

The user may enter the user interface flow in the user interface diagram 300 by receiving a push notification 305. The user interface may display the push notification based on the user device receiving a payload from a server associated with the custodial token platform. For example, receipt of the payload may cause display of the push notification.

The server may transmit the payload based on determining that a current characteristic of a crypto token (e.g., a crypto token 325) satisfies a notification condition associated with the application of the user device. For example, a user profile associated with the application may be classified as interested in the token based on an amount of the crypto token being attributed to the user profile or the user profile having flagged the crypto token. For example, the user may add the crypto token to a favorites list (or similar indication) in the user profile such that the user is classified as interested in the token. If the crypto token is attributed to the user profile, then a wallet address associated with or accessible via the user profile may store the amount of crypto token (e.g., the amount of the crypto token is attributed to the wallet address via the blockchain network). That is, the user profile may have purchased or traded for the crypto token previously via the custodial token platform. Additionally, or alternatively, the wallet address may receive the crypto token via a transaction via the blockchain network. Accordingly, the user profile may be classified as interested in the crypto token based on one or more characteristics.

The notification condition may be the current characteristic being within a threshold of a support level or a resistance level. Or the notification condition may be the current characteristic exceeding the support level or resistance level. As described herein, the custodial token platform may determine the support or resistance levels, obtain a current price, and evaluate whether the condition is satisfied. If the condition is satisfied, then the custodial token platform may identify users to receive the push notification based on whether or not the user profiles are classified as interested, as described herein.

The user may interact with the push notification 305. For example, the user may select the push notification 305 to request more information associated with the current characteristic of the crypto token. That is, the user may provide an input activating the push notification 305.

Based on the input, the user interface may display a notification page of the application including one or more notifications 310 (e.g., including or in addition to the push notification 305). The notification page may include a price alert 315, a trading insight 320, and one or more other notification types. For example, the price alert 315 may be associated with a percent change (e.g., over the past day, week, year, etc.). Additionally, or alternatively, the trading insight 320 may be associated with a change in the price relative to the threshold support level or resistance level, or the price exceeding the support level or resistance level.

The user may interact with the price alert 315, the trading insight 320, or both. The user interface may display a token page based on one or more inputs from the user. For example, the price alert 315 may be associated with a first crypto token, and the trading insight may be associated with a second crypto token. The user may select the price alert 315, and the user interface may display a first token page associated with the first crypto token. Or the user may select the trading insight 320, and the user interface may display a second token page associated with the second crypto token.

The token page may include an indication of the crypto token 325, a price 330 (e.g., a current price), a price change 335 (e.g., relative to the past day, week, year, etc.), a price chart 340, a timeframe 345 (e.g., associated with the price chart 340), one or more trading options 350, and a balance 355.

For example, the token page may display the price chart 340 corresponding to the timeframe 345, which may be changed via user selection. The price chart 340 may include one or more threshold or resistance lines associated with the crypto token 325.

The user may select to buy, sell, trade, convert, send, or receive an amount of the crypto token 325 via the one or more trading options 350. For example, based on the price 330, the price change 335, or the like, the user may select one of the one or more trading options 350 or refrain from selecting one of the one or more trading options 350.

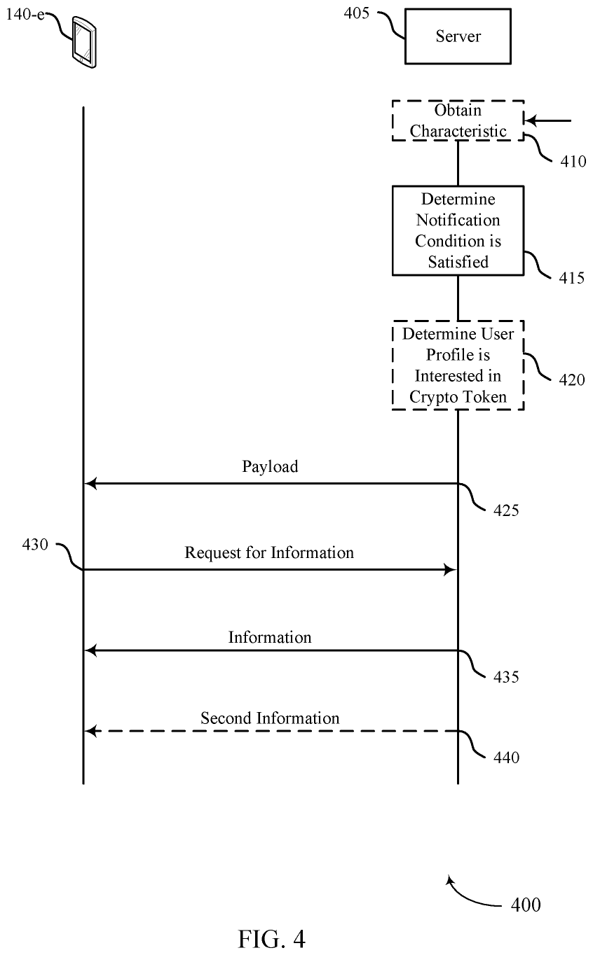

FIG. 4 shows an example of a process flow 400 that supports crypto token threshold notifications in accordance with aspects of the present disclosure. The process flow 400 may include a computing device 140-e, which may be an example of the computing devices 140 as described with reference to FIGS. 1 and 2. The process flow 400 may also include a server 405, which may be an example of corresponding devices as described with reference to FIG. 2. For example, the server 405 is an example of or represents one or more servers that support a custodial token platform and/or an application used to access a custodial token platform as described herein. In the following description of the process flow 400, the operations between the computing device 140-e and the server 405 may be transmitted in a different order than the example order shown, or the operations performed may be performed in different orders or at different times. Some operations may also be omitted from the process flow 400, and other operations may be added to the process flow 400.

At 410, the server 405 may obtain a characteristic. For example, the server 405 may obtain a current characteristic, support level, resistance level, or the like from one or more servers that support a custodial token platform. As described herein, the server 450 may execute one or more jobs that determine support levels, resistance levels, or both over a period of time and evaluate a current price relative to the support levels, resistance levels, or both.

At 415, the server 405 may determine that a notification condition is satisfied. For example, the server 405 may determine that the current condition of a crypto token satisfies the notification condition associated with an application (e.g., an application of the custodial token platform) on one or more user devices (e.g., the computing device 140-e). As described herein, the server 405 may execute one or jobs that obtain the current price and the support/resistance levels to determine whether the notification is satisfied for one or more multiple crypto tokens.

In some examples, the notification condition may be satisfied based on the current characteristic (e.g., price) relative to a support level or a resistance level determined using exchange activity data associated with the crypto token. For example, the exchange activity data may include historical data associated with support levels, resistance levels, or both for the crypto token.

At 420, the server 405 may determine that a user profile is interested in the crypto token. For example, the server 450 may determine that the user profile associated with the application on the computing device 140-e is classified as interested in the crypto token. In some examples, the user profile may be classified as interested in the crypto token based on an amount of the crypto token attributed to the user profile (e.g., a non-zero amount, an amount above a threshold amount, etc.) or the user profile having flagged the crypto token (e.g., favorited the crypto token).

At 425, the server 405 may transmit a payload to the computing device 140-e. For example, the server 405 may transmit the payload based on (e.g., after) determining that the current characteristic satisfies the notification condition. In some examples, the payload may cause a push notification associated with the application at the computing device 140-e to be displayed (e.g., via a user interface of the computing device 140-e) at the computing device 140-e.

Additionally, or alternatively, the payload may cause display of a display card in a main feed page of the application, where the display card may be indicative of the notification condition. For example, the application on the computing device 140-e may display one or more notifications including information associated with the push notification.

At 430, the computing device 140-e may transmit a request for more to the server 405. For example, the computing device 140-e may receive an input activating the push notification (e.g., a selection of the push notification), and, based on receiving the input, transmit the request for more information associated with the crypto token.

At 435, the server 405 may transmit information to the computing device 140-e. For example, the server 405, after receiving the request for information at 430 (e.g., based on receiving the request), may transmit a response including the information associated with the crypto token. In some examples, the response may cause display of a token page associated with the crypto token via the application on a user interface of the computing device 140-e. For example, the token page may include notification condition information included in the payload.

Additionally, or alternatively, the token page may be configured to display one or more threshold or resistance lines on a characteristic chart (e.g., price chart) associated with the crypto token. In some examples, the token page may also be configured to display the characteristic chart associated with the crypto token in conjunction with the notification condition information included in the payload. The server may transmit information associated with the characteristic chart via a response to the request for information at 435.

At 440, the server may transmit second information to the computing device 140-e. For example, the second information may be associated with a second crypto token. Transmission of the second information may cause display, at the user interface of the computing device 140-e, of a second token page including an indication of one or more threshold or resistance lines associated with the second crypto token.

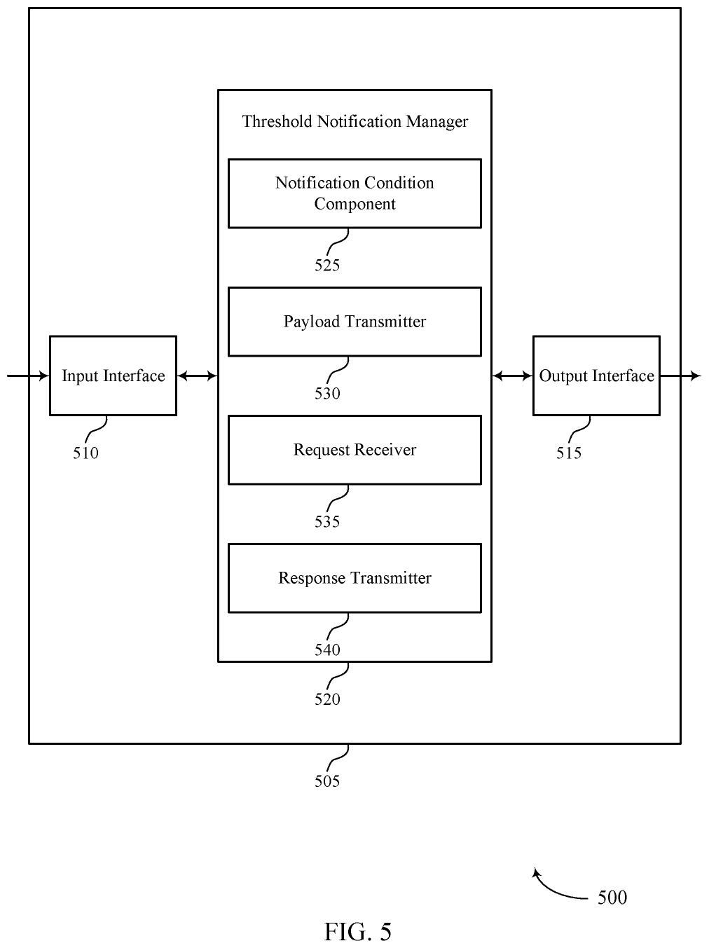

FIG. 5 shows a block diagram 500 of a system 505 that supports crypto token threshold notifications in accordance with aspects of the present disclosure. The system 505 may include an input interface 510, an output interface 515, and a threshold notification manager 520. The system 505, or one or more components of the system 505 (e.g., the input interface 510, the output interface 515, and the threshold notification manager 520), may include at least one processor, which may be coupled with at least one memory, to support the described techniques. Each of these components may be in communication with one another (e.g., via one or more buses).

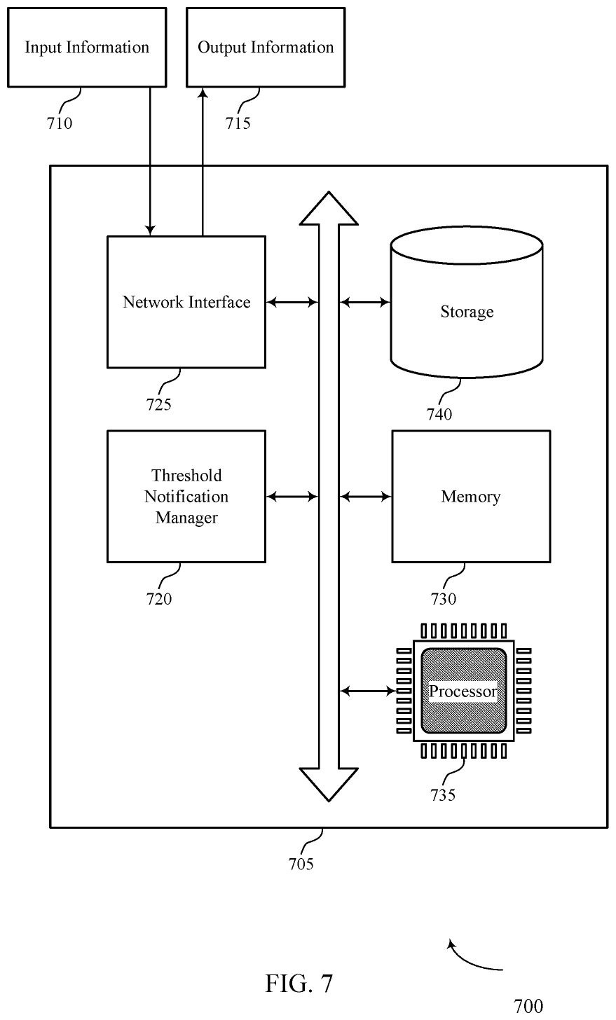

The input interface 510 may manage input signaling for the system 505. For example, the input interface 510 may receive input signaling (e.g., messages, packets, data, instructions, commands, transactions, or any other form of encoded information) from other systems or devices. The input interface 510 may send signaling corresponding to (e.g., representative of or otherwise based on) such input signaling to other components of the system 505 for processing. For example, the input interface 510 may transmit such corresponding signaling to the threshold notification manager 520 to support crypto token threshold notifications. In some cases, the input interface 510 may be a component of a network interface 725 as described with reference to FIG. 7.

The output interface 515 may manage output signaling for the system 505. For example, the output interface 515 may receive signaling from other components of the system 505, such as the threshold notification manager 520, and may transmit such output signaling corresponding to (e.g., representative of or otherwise based on) such signaling to other systems or devices. In some cases, the output interface 515 may be a component of a network interface 725 as described with reference to FIG. 7.

For example, the threshold notification manager 520 may include a notification condition component 525, a payload transmitter 530, a request receiver 535, a response transmitter 540, or any combination thereof. In some examples, the threshold notification manager 520, or various components thereof, may be configured to perform various operations (e.g., receiving, monitoring, transmitting) using or otherwise in cooperation with the input interface 510, the output interface 515, or both. For example, the threshold notification manager 520 may receive information from the input interface 510, send information to the output interface 515, or be integrated in combination with the input interface 510, the output interface 515, or both to receive information, transmit information, or perform various other operations as described herein.

The notification condition component 525 may be configured as or otherwise support a means for determining that a current characteristic of a crypto token satisfies a notification condition associated with an application on one or more user devices. The payload transmitter 530 may be configured as or otherwise support a means for transmitting, after determining that the current characteristic satisfies the notification condition, a payload that causes a push notification associated with the application on a user device to be displayed at the user device, wherein the push notification is indicative of the notification condition. The request receiver 535 may be configured as or otherwise support a means for receiving, from the application, a request for information associated with the crypto token, wherein the request is received in response to input, at the user device, that activates the push notification. The response transmitter 540 may be configured as or otherwise support a means for transmitting, after receiving the request, a response that includes the information associated with the crypto token, wherein the response causes display, via the application, of an token page associated with the crypto token and wherein the token page includes notification condition information included in the payload.

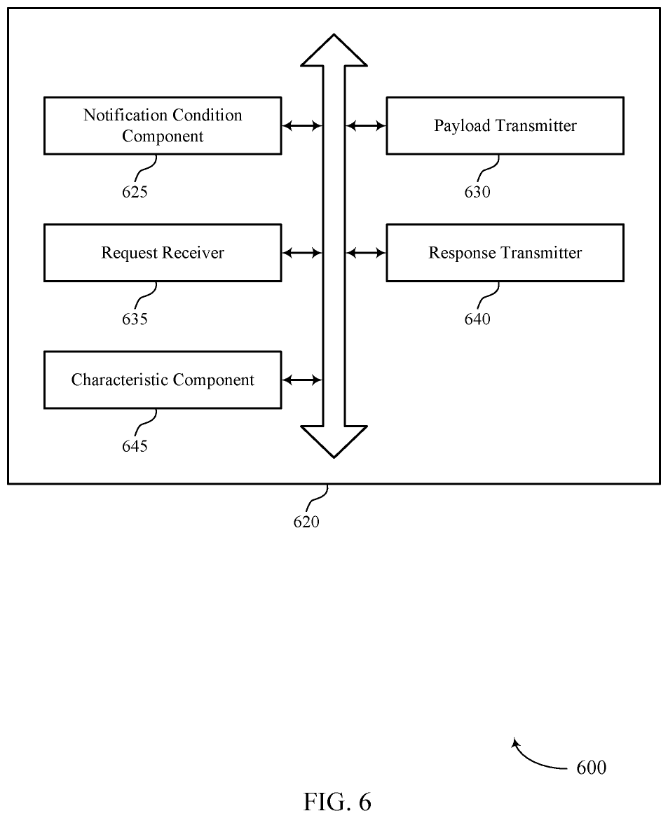

FIG. 6 shows a block diagram 600 of a threshold notification manager 620 that supports crypto token threshold notifications in accordance with aspects of the present disclosure. The threshold notification manager 620 may be an example of aspects of a threshold notification manager or a threshold notification manager 520, or both, as described herein. The threshold notification manager 620, or various components thereof, may be an example of means for performing various aspects of crypto token threshold notifications as described herein. For example, the threshold notification manager 620 may include a notification condition component 625, a payload transmitter 630, a request receiver 635, a response transmitter 640, a characteristic component 645, or any combination thereof. Each of these components, or components of subcomponents thereof (e.g., one or more processors, one or more memories), may communicate, directly or indirectly, with one another (e.g., via one or more buses).

The notification condition component 625 may be configured as or otherwise support a means for determining that a current characteristic of a crypto token satisfies a notification condition associated with an application on one or more user devices. The payload transmitter 630 may be configured as or otherwise support a means for transmitting, after determining that the current characteristic satisfies the notification condition, a payload that causes a push notification associated with the application on a user device to be displayed at the user device, wherein the push notification is indicative of the notification condition. The request receiver 635 may be configured as or otherwise support a means for receiving, from the application, a request for information associated with the crypto token, wherein the request is received in response to input, at the user device, that activates the push notification. The response transmitter 640 may be configured as or otherwise support a means for transmitting, after receiving the request, a response that includes the information associated with the crypto token, wherein the response causes display, via the application, of an token page associated with the crypto token and wherein the token page includes notification condition information included in the payload.

In some examples, to support determining that the current characteristic satisfies the notification condition, the notification condition component 625 may be configured as or otherwise support a means for determining that a user profile associated with the application on the user device is classified as interested in the crypto token, wherein the payload is transmitted based at least in part on the user profile being classified as interested in the crypto token.

In some examples, the user profile is classified as interested in the crypto token based at least in part on an amount of the crypto token attributed to the user profile or the user profile having flagged the crypto token.

In some examples, to support determining that the current characteristic satisfies the notification condition, the characteristic component 645 may be configured as or otherwise support a means for obtaining, from one or more servers that support a custodial token platform, the current characteristic, a support level, a resistance level, or a combination thereof. In some examples, to support determining that the current characteristic satisfies the notification condition, the notification condition component 625 may be configured as or otherwise support a means for determining that the current characteristic is within a threshold characteristic of the support level or the resistance level or that the current characteristic exceeds the support level or the resistance level.

In some examples, the token page is configured to display one or more threshold or resistance lines on a characteristic chart associated with the crypto token.

In some examples, the token page is configured to display a characteristic chart associated with the crypto token in conjunction with the notification condition information included in the payload, wherein information associated with the characteristic chart is transmitted via the response.

In some examples, the response transmitter 640 may be configured as or otherwise support a means for transmitting second information associated with a second crypto token, wherein the second information causes display, via the application, of a second token page including an indication of one or more threshold or resistance lines associated with the second crypto token.

In some examples, the notification condition is satisfied based at least in part on the current characteristic relative to a support level or a resistance level determined using exchange activity data associated with the crypto token.

In some examples, the payload causes display of a display card in a main feed page of the application, wherein the display card is indicative of the notification condition.

FIG. 7 shows a diagram of a system 700 including a device 705 that supports crypto token threshold notifications in accordance with aspects of the present disclosure. The device 705 may be an example of or include the components of a system 505 as described herein. The device 705 may include components for crypto token threshold notifications, such as a threshold notification manager 720, an input information 710, an output information 715, a network interface 725, at least one memory 730, at least one processor 735, and a storage 740. Each of these components may communicate, directly or indirectly, with one another (e.g., via one or more buses, communications links, communications interfaces, or any combination thereof).

The network interface 725 may enable the device 705 to exchange information (e.g., input information 710, output information 715, or both) with other systems or devices (not shown). For example, the network interface 725 may enable the device 705 to connect to a network (e.g., a network 135 as described herein). The network interface 725 may include one or more wireless network interfaces, one or more wired network interfaces, or any combination thereof.

Memory 730 may include RAM, ROM, or both. The memory 730 may store computer-readable, computer-executable software including instructions that, when executed, cause at least one processor 735 to perform various functions described herein, such as functions supporting crypto token threshold notifications. In some cases, the memory 730 may contain, among other things, a basic input/output system (BIOS), which may control basic hardware or software operation such as the interaction with peripheral components or devices. In some cases, the memory 730 may be an example of aspects of one or more components of a custodial token platform 110 as described with reference to FIG. 1. The memory 730 may be an example of a single memory or multiple memories. For example, the device 705 may include one or more memories 730.

The processor 735 may include an intelligent hardware device, (e.g., a general-purpose processor, a DSP, a CPU, a microcontroller, an ASIC, a field programmable gate array (FPGA), a programmable logic device, a discrete gate or transistor logic component, a discrete hardware component, or any combination thereof). The processor 735 may be configured to execute computer-readable instructions stored in at least one memory 730 to perform various functions (e.g., functions or tasks supporting crypto token threshold notifications). Though a single processor 735 is depicted in the example of FIG. 7, it is to be understood that the device 705 may include any quantity of one or more of processors 735 and that a group of processors 735 may collectively perform one or more functions ascribed herein to a processor, such as the processor 735. The processor 735 may be an example of a single processor or multiple processors. For example, the device 705 may include one or more processors 735.

Storage 740 may be configured to store data that is generated, processed, stored, or otherwise used by the device 705. In some cases, the storage 740 may include one or more HDDs, one or more SDDs, or both. In some examples, the storage 740 may be an example of a single database, a distributed database, multiple distributed databases, a data store, a data lake, or an emergency backup database.

For example, the threshold notification manager 720 may be configured as or otherwise support a means for determining that a current characteristic of a crypto token satisfies a notification condition associated with an application on one or more user devices. The threshold notification manager 720 may be configured as or otherwise support a means for transmitting, after determining that the current characteristic satisfies the notification condition, a payload that causes a push notification associated with the application on a user device to be displayed at the user device, wherein the push notification is indicative of the notification condition. The threshold notification manager 720 may be configured as or otherwise support a means for receiving, from the application, a request for information associated with the crypto token, wherein the request is received in response to input, at the user device, that activates the push notification. The threshold notification manager 720 may be configured as or otherwise support a means for transmitting, after receiving the request, a response that includes the information associated with the crypto token, wherein the response causes display, via the application, of an token page associated with the crypto token and wherein the token page includes notification condition information included in the payload.

By including or configuring the threshold notification manager 720 in accordance with examples as described herein, the device 705 may support techniques for improved user experience.

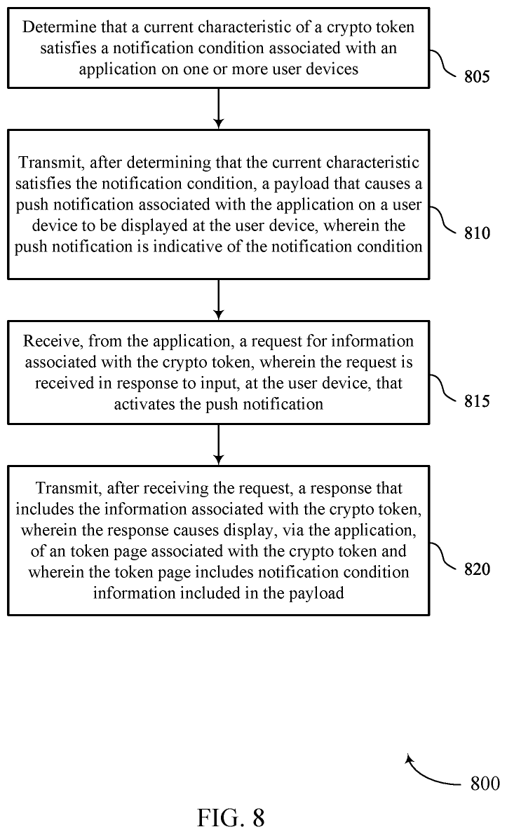

FIG. 8 shows a flowchart illustrating a method 800 that supports crypto token threshold notifications in accordance with aspects of the present disclosure. The operations of the method 800 may be implemented by a server or its components as described herein. For example, the operations of the method 800 may be performed by a server as described with reference to FIGS. 1 through 7. In some examples, a server may execute a set of instructions to control the functional elements of the server to perform the described functions. Additionally, or alternatively, the server may perform aspects of the described functions using special-purpose hardware.

At 805, the method may include determining that a current characteristic of a crypto token satisfies a notification condition associated with an application on one or more user devices. The operations of block 805 may be performed in accordance with examples as disclosed herein. In some examples, aspects of the operations of 805 may be performed by a notification condition component 625 as described with reference to FIG. 6.

At 810, the method may include transmitting, after determining that the current characteristic satisfies the notification condition, a payload that causes a push notification associated with the application on a user device to be displayed at the user device, wherein the push notification is indicative of the notification condition. The operations of block 810 may be performed in accordance with examples as disclosed herein. In some examples, aspects of the operations of 810 may be performed by a payload transmitter 630 as described with reference to FIG. 6.

At 815, the method may include receiving, from the application, a request for information associated with the crypto token, wherein the request is received in response to input, at the user device, that activates the push notification. The operations of block 815 may be performed in accordance with examples as disclosed herein. In some examples, aspects of the operations of 815 may be performed by a request receiver 635 as described with reference to FIG. 6.

At 820, the method may include transmitting, after receiving the request, a response that includes the information associated with the crypto token, wherein the response causes display, via the application, of an token page associated with the crypto token and wherein the token page includes notification condition information included in the payload. The operations of block 820 may be performed in accordance with examples as disclosed herein. In some examples, aspects of the operations of 820 may be performed by a response transmitter 640 as described with reference to FIG. 6.

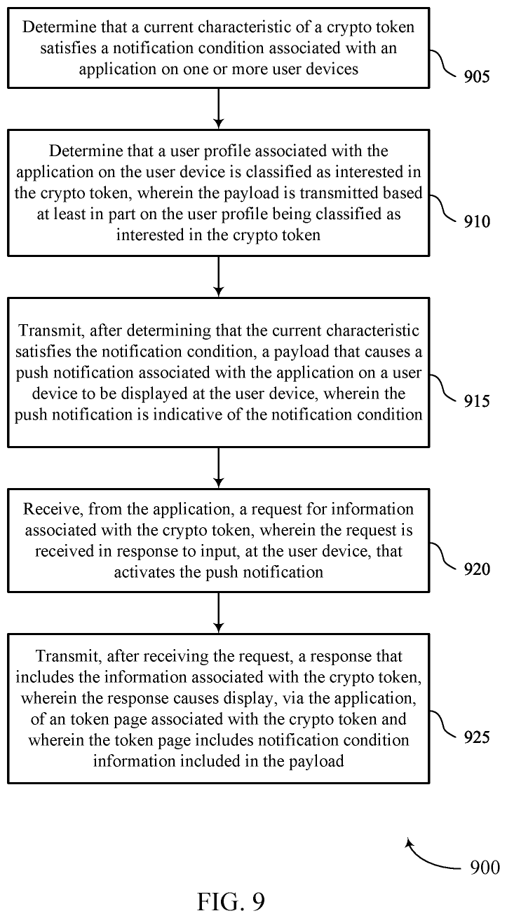

FIG. 9 shows a flowchart illustrating a method 900 that supports crypto token threshold notifications in accordance with aspects of the present disclosure. The operations of the method 900 may be implemented by a server or its components as described herein. For example, the operations of the method 900 may be performed by a server as described with reference to FIGS. 1 through 7. In some examples, a server may execute a set of instructions to control the functional elements of the server to perform the described functions. Additionally, or alternatively, the server may perform aspects of the described functions using special-purpose hardware.

At 905, the method may include determining that a current characteristic of a crypto token satisfies a notification condition associated with an application on one or more user devices. The operations of block 905 may be performed in accordance with examples as disclosed herein. In some examples, aspects of the operations of 905 may be performed by a notification condition component 625 as described with reference to FIG. 6.

At 910, the method may include determining that a user profile associated with the application on the user device is classified as interested in the crypto token, wherein the payload is transmitted based at least in part on the user profile being classified as interested in the crypto token. The operations of block 910 may be performed in accordance with examples as disclosed herein. In some examples, aspects of the operations of 910 may be performed by a notification condition component 625 as described with reference to FIG. 6.

At 915, the method may include transmitting, after determining that the current characteristic satisfies the notification condition, a payload that causes a push notification associated with the application on a user device to be displayed at the user device, wherein the push notification is indicative of the notification condition. The operations of block 915 may be performed in accordance with examples as disclosed herein. In some examples, aspects of the operations of 915 may be performed by a payload transmitter 630 as described with reference to FIG. 6.

At 920, the method may include receiving, from the application, a request for information associated with the crypto token, wherein the request is received in response to input, at the user device, that activates the push notification. The operations of block 920 may be performed in accordance with examples as disclosed herein. In some examples, aspects of the operations of 920 may be performed by a request receiver 635 as described with reference to FIG. 6.

At 925, the method may include transmitting, after receiving the request, a response that includes the information associated with the crypto token, wherein the response causes display, via the application, of an token page associated with the crypto token and wherein the token page includes notification condition information included in the payload. The operations of block 925 may be performed in accordance with examples as disclosed herein. In some examples, aspects of the operations of 925 may be performed by a response transmitter 640 as described with reference to FIG. 6.

A method by an apparatus is described. The method may include determining that a current characteristic of a crypto token satisfies a notification condition associated with an application on one or more user devices, transmitting, after determining that the current characteristic satisfies the notification condition, a payload that causes a push notification associated with the application on a user device to be displayed at the user device, wherein the push notification is indicative of the notification condition, receiving, from the application, a request for information associated with the crypto token, wherein the request is received in response to input, at the user device, that activates the push notification, and transmitting, after receiving the request, a response that includes the information associated with the crypto token, wherein the response causes display, via the application, of an token page associated with the crypto token and wherein the token page includes notification condition information included in the payload.

An apparatus is described. The apparatus may include one or more memories storing processor executable code, and one or more processors coupled with the one or more memories. The one or more processors may individually or collectively operable to execute the code to cause the apparatus to determine that a current characteristic of a crypto token satisfies a notification condition associated with an application on one or more user devices, transmit, after determining that the current characteristic satisfies the notification condition, a payload that causes a push notification associated with the application on a user device to be displayed at the user device, wherein the push notification is indicative of the notification condition, receive, from the application, a request for information associated with the crypto token, wherein the request is received in response to input, at the user device, that activates the push notification, and transmit, after receiving the request, a response that includes the information associated with the crypto token, wherein the response causes display, via the application, of an token page associated with the crypto token and wherein the token page includes notification condition information included in the payload.

Another apparatus is described. The apparatus may include means for determining that a current characteristic of a crypto token satisfies a notification condition associated with an application on one or more user devices, means for transmitting, after determining that the current characteristic satisfies the notification condition, a payload that causes a push notification associated with the application on a user device to be displayed at the user device, wherein the push notification is indicative of the notification condition, means for receiving, from the application, a request for information associated with the crypto token, wherein the request is received in response to input, at the user device, that activates the push notification, and means for transmitting, after receiving the request, a response that includes the information associated with the crypto token, wherein the response causes display, via the application, of an token page associated with the crypto token and wherein the token page includes notification condition information included in the payload.

A non-transitory computer-readable medium storing code is described. The code may include instructions executable by a processor to determine that a current characteristic of a crypto token satisfies a notification condition associated with an application on one or more user devices, transmit, after determining that the current characteristic satisfies the notification condition, a payload that causes a push notification associated with the application on a user device to be displayed at the user device, wherein the push notification is indicative of the notification condition, receive, from the application, a request for information associated with the crypto token, wherein the request is received in response to input, at the user device, that activates the push notification, and transmit, after receiving the request, a response that includes the information associated with the crypto token, wherein the response causes display, via the application, of an token page associated with the crypto token and wherein the token page includes notification condition information included in the payload.

In some examples of the method, apparatus, and non-transitory computer-readable medium described herein, determining that the current characteristic satisfies the notification condition may include operations, features, means, or instructions for determining that a user profile associated with the application on the user device may be classified as interested in the crypto token, wherein the payload may be transmitted based at least in part on the user profile being classified as interested in the crypto token.

In some examples of the method, apparatus, and non-transitory computer-readable medium described herein, the user profile may be classified as interested in the crypto token based at least in part on an amount of the crypto token attributed to the user profile or the user profile having flagged the crypto token.

In some examples of the method, apparatus, and non-transitory computer-readable medium described herein, determining that the current characteristic satisfies the notification condition may include operations, features, means, or instructions for obtaining, from one or more servers that support a custodial token platform, the current characteristic, a support level, a resistance level, or a combination thereof and determining that the current characteristic may be within a threshold characteristic of the support level or the resistance level or that the current characteristic exceeds the support level or the resistance level.

In some examples of the method, apparatus, and non-transitory computer-readable medium described herein, the token page may be configured to display one or more threshold or resistance lines on a characteristic chart associated with the crypto token.

In some examples of the method, apparatus, and non-transitory computer-readable medium described herein, the token page may be configured to display a characteristic chart associated with the crypto token in conjunction with the notification condition information included in the payload, wherein information associated with the characteristic chart may be transmitted via the response.

Some examples of the method, apparatus, and non-transitory computer-readable medium described herein may further include operations, features, means, or instructions for transmitting second information associated with a second crypto token, wherein the second information causes display, via the application, of a second token page including an indication of one or more threshold or resistance lines associated with the second crypto token.

In some examples of the method, apparatus, and non-transitory computer-readable medium described herein, the notification condition may be satisfied based at least in part on the current characteristic relative to a support level or a resistance level determined using exchange activity data associated with the crypto token.

In some examples of the method, apparatus, and non-transitory computer-readable medium described herein, the payload causes display of a display card in a main feed page of the application, wherein the display card may be indicative of the notification condition.

It should be noted that the methods described above describe possible implementations, and that the operations and the steps may be rearranged or otherwise modified and that other implementations are possible. Furthermore, aspects from two or more of the methods may be combined.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Further, a system as used herein may be a collection of devices, a single device, or aspects within a single device.

Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, EEPROM) compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method notification management, comprising:
determining that a current characteristic of a crypto token satisfies a notification condition associated with an application on one or more user devices;
transmitting, after determining that the current characteristic satisfies the notification condition, a payload that causes a push notification associated with the application on a user device to be displayed at the user device, wherein the push notification is indicative of the notification condition;
receiving, from the application, a request for information associated with the crypto token, wherein the request is received in response to an input, at the user device, that activates the push notification; and
transmitting, after receiving the request, a response that includes the information associated with the crypto token, wherein the response causes display, via the application, of an token page associated with the crypto token and wherein the token page includes notification condition information included in the payload.

2. The method of claim 1, wherein determining that the current characteristic satisfies the notification condition comprises:
determining that a user profile associated with the application on the user device is classified as interested in the crypto token, wherein the payload is transmitted based at least in part on the user profile being classified as interested in the crypto token.

3. The method of claim 2, wherein the user profile is classified as interested in the crypto token based at least in part on an amount of the crypto token attributed to the user profile or the user profile having flagged the crypto token.

4. The method of claim 1, wherein determining that the current characteristic satisfies the notification condition comprises:
obtaining, from one or more servers that support a custodial token platform, the current characteristic, a support level, a resistance level, or a combination thereof; and
determining that the current characteristic is within a threshold characteristic of the support level or the resistance level or that the current characteristic exceeds the support level or the resistance level.

5. The method of claim 1, wherein the token page is configured to display one or more threshold or resistance lines on a characteristic chart associated with the crypto token.

6. The method of claim 1, wherein the token page is configured to display a characteristic chart associated with the crypto token in conjunction with the notification condition information included in the payload, wherein information associated with the characteristic chart is transmitted via the response.

7. The method of claim 1, further comprising:
transmitting second information associated with a second crypto token, wherein the second information causes display, via the application, of a second token page including an indication of one or more threshold or resistance lines associated with the second crypto token.

8. The method of claim 1, wherein the notification condition is satisfied based at least in part on the current characteristic relative to a support level or a resistance level determined using exchange activity data associated with the crypto token. 9 The method of claim 1, wherein the payload causes display of a display card in a main feed page of the application, wherein the display card is indicative of the notification condition.

10. An apparatus, comprising:
one or more memories storing processor-executable code; and
one or more processors coupled with the one or more memories and individually or collectively operable to execute the code to cause the apparatus to:
determine that a current characteristic of a crypto token satisfies a notification condition associated with an application on one or more user devices;
transmit, after determining that the current characteristic satisfies the notification condition, a payload that causes a push notification associated with the application on a user device to be displayed at the user device, wherein the push notification is indicative of the notification condition;
receive, from the application, a request for information associated with the crypto token, wherein the request is received in response to input, at the user device, that activates the push notification; and
transmit, after receiving the request, a response that includes the information associated with the crypto token, wherein the response causes display, via the application, of an token page associated with the crypto token and wherein the token page includes notification condition information included in the payload.

11. The apparatus of claim 10, wherein, to determine that the current characteristic satisfies the notification condition, the one or more processors are individually or collectively operable to execute the code to cause the apparatus to:
determine that a user profile associated with the application on the user device is classified as interested in the crypto token, wherein the payload is transmitted based at least in part on the user profile being classified as interested in the crypto token.

12. The apparatus of claim 11, wherein the user profile is classified as interested in the crypto token based at least in part on an amount of the crypto token attributed to the user profile or the user profile having flagged the crypto token.

13. The apparatus of claim 10, wherein, to determine that the current characteristic satisfies the notification condition, the one or more processors are individually or collectively operable to execute the code to cause the apparatus to:
obtain, from one or more servers that support a custodial token platform, the current characteristic, a support level, a resistance level, or a combination thereof; and
determine that the current characteristic is within a threshold characteristic of the support level or the resistance level or that the current characteristic exceeds the support level or the resistance level.

14. The apparatus of claim 10, wherein the token page is configured to display one or more threshold or resistance lines on a characteristic chart associated with the crypto token.

15. The apparatus of claim 10, wherein the token page is configured to display a characteristic chart associated with the crypto token in conjunction with the notification condition information included in the payload, wherein information associated with the characteristic chart is transmitted via the response.

16. The apparatus of claim 10, wherein the one or more processors are individually or collectively further operable to execute the code to cause the apparatus to:
transmit second information associated with a second crypto token, wherein the second information causes display, via the application, of a second token page including an indication of one or more threshold or resistance lines associated with the second crypto token.

17. A non-transitory computer-readable medium storing code, the code comprising instructions executable by one or more processors to:
determine that a current characteristic of a crypto token satisfies a notification condition associated with an application on one or more user devices;
transmit, after determining that the current characteristic satisfies the notification condition, a payload that causes a push notification associated with the application on a user device to be displayed at the user device, wherein the push notification is indicative of the notification condition;
receive, from the application, a request for information associated with the crypto token, wherein the request is received in response to input, at the user device, that activates the push notification; and
transmit, after receiving the request, a response that includes the information associated with the crypto token, wherein the response causes display, via the application, of an token page associated with the crypto token and wherein the token page includes notification condition information included in the payload.

18. The non-transitory computer-readable medium of claim 17, wherein the instructions to determine that the current characteristic satisfies the notification condition are executable by the one or more processors to:
obtain, from one or more servers that support a custodial token platform, the current characteristic, a support level, a resistance level, or a combination thereof; and
determine that the current characteristic is within a threshold characteristic of the support level or the resistance level or that the current characteristic exceeds the support level or the resistance level.

19. The non-transitory computer-readable medium of claim 17, wherein the token page is configured to display one or more threshold or resistance lines on a characteristic chart associated with the crypto token.

20. The non-transitory computer-readable medium of claim 17, wherein the token page is configured to display a characteristic chart associated with the crypto token in conjunction with the notification condition information included in the payload, wherein information associated with the characteristic chart is transmitted via the response.
